(19) United States
(12) Patent Application Publication
(10) Pub. No.: US 2008/0143522 A1
(43) Pub. Date: Jun. 19, 2008

(54) PORTABLE COMPUTER AND MOBILE PHONE

(75) Inventor: Kuo-Chung Sung, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/876,780

(22) Filed: Oct. 23, 2007

(30) Foreign Application Priority Data
Dec. 13, 2006 (TW) 95146581

(51) Int. Cl. G08B 17/00; G08B 21/00

(52) U.S. Cl. 340/540; 340/584; 340/665; 340/689; 340/690

(57) ABSTRACT

A portable computer and mobile phone are provided. The portable computer includes a data processing module, an environment parameter sensor and a screen. The environment parameter sensor is electrically connected to the data processing module to transmit a sensed environment parameter to the data processing module. The screen is electrically connected to the data processing module to show the environment parameter. The mobile phone includes a control module, a communication module, an environment parameter sensor and a screen. The communication module is electrically connected to the control module. The environment parameter sensor is electrically connected to the control module to transmit a sensed environment parameter to the control module. The screen is electrically connected to the control module to show the environment parameter.

### CROSS-REFERENCE TO RELATED APPLICATION

This application claims the priority benefit of Taiwan application serial no. 95146581, filed on Dec. 13, 2006. All disclosure of the Taiwan application is incorporated herein by reference.

### BACKGROUND OF THE INVENTION

1. Field of the Invention

The present invention relates to a portable computer and mobile phone and, more particularly, to a portable computer and mobile phone which can sense and show an environment parameter.

2. Description of the Related Art

With the development of the science and technology, notebook computers and mobile phones become smaller, lighter, more convenient to carry and multifunctional, they are more and more popular and inseparable in the daily life. However, the functions of sensing and showing temperature, orientation, pressure, altitude and so on are not provided by a conventional multi-functioned notebook computer or a mobile phone. Although a user often carries a notebook computer or a mobile phone, one still can not know the information such as temperature, orientation, pressure, or altitude of the local environment timely from the carried notebook computer or mobile phone. The only way to get such information is from other electronic apparatuses. It is inconvenient for the user to carry additional electronic apparatus to detect the environment parameters when such information is important for the user's reference.

### BRIEF SUMMARY OF THE INVENTION

One objective of the present invention is to provide a portable computer to provide functions of sensing and showing an environment parameter.

Another objective of the present invention is to provide a mobile phone to provide the functions of sensing and showing an environment parameter.

To obtain the above or other objections, the present invention provides a portable computer including a data processing module, an environment parameter sensor and a screen. The environment parameter sensor is electrically connected to the data processing module to transmit a sensed environment parameter to the data processing module. The screen is electrically connected to the data processing module to show the environment parameter.

To obtain the above and other objectives, the present invention further provides a mobile phone including a control module, a communication module, an environment parameter sensor and a screen. The communication module is electrically connected to the control module. The environment parameter sensor is electrically connected to the control module to transmit a sensed environment parameter to the control module. The screen is electrically connected to the control module to show the environment parameter.

In one embodiment of the present invention, the environment parameter includes at least one of temperature, orientation, pressure and altitude.

In one embodiment of the present invention, the environment parameter sensor is located at one side of the screen. For example, the environment parameter sensor is located at one corner of the screen.

Since the portable computer and mobile phone of the present invention have the environment parameter sensors, environment parameters can be sensed and shown on the screens timely and locally. In this way, a user can obtain an environment parameter timely and locally without carrying and using other electronic apparatuses. Thus, the portable computer and mobile phone of the present invention is much more convenient to users.

These and other features, aspects, and advantages of the present invention will become better understood with regard to the following description, appended claims, and accompanying drawings.

### BRIEF DESCRIPTION OF THE DRAWINGS

FIG. 1 is a block diagram showing a portable computer of one embodiment of the present invention.

FIG. 2 is a three-dimensional schematic diagram of a portable computer of another embodiment of the present invention.

FIG. 3 is a three-dimensional schematic diagram of a portable computer of another embodiment of the present invention.

FIG. 4A is a block diagram showing a mobile phone of one embodiment of the present invention.

FIG. 4B is a schematic diagram showing the mobile phone shown in FIG. 4A.

### DETAILED DESCRIPTION OF THE EMBODIMENTS

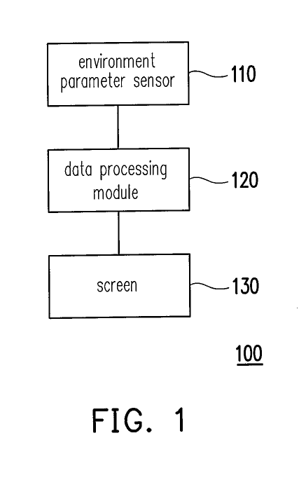

FIG. 1 is a block diagram showing a portable computer of one embodiment of the present invention. Referring to FIG. 1, a portable computer 100 of the embodiment includes a data processing module 120, an environment parameter sensor 110 and a screen 130. The environment parameter sensor 110 is electrically connected to the data processing module 120 to transmit a sensed environment parameter to the data processing module 120. The screen 130 is electrically connected to the data processing module 120 to show the environment parameter.

In the embodiment, the environment parameter sensed by the environment parameter sensor 110 and shown by the screen 130 includes at least one of the temperature, orientation, pressure and altitude. Wherein, the orientation means the direction that the portable computer 100 locates, which may be east, west, south, north or more precise direction. Certainly, the environment parameter can also be longitude, latitude or other environment parameters. For example, the environment parameter sensor 110 includes at least one of a temperature sensor unit, an orientation sensor unit, a pressure sensor unit and an altitude sensor unit to sense the temperature, orientation, pressure and altitude, respectively. Otherwise, the environment parameter sensor 110 can also sense a plurality of environment parameters simultaneously by a single sensor unit.

Since the portable computer 100 of the embodiment has the environment parameter sensor 110, the environment parameter can be sensed timely and locally and shown on the screen 130. In this way, a user can obtain the environment parameter timely and locally without carrying and using other electronic apparatuses. Thus, the portable computer 100 of the embodiment is much more convenient to the users.

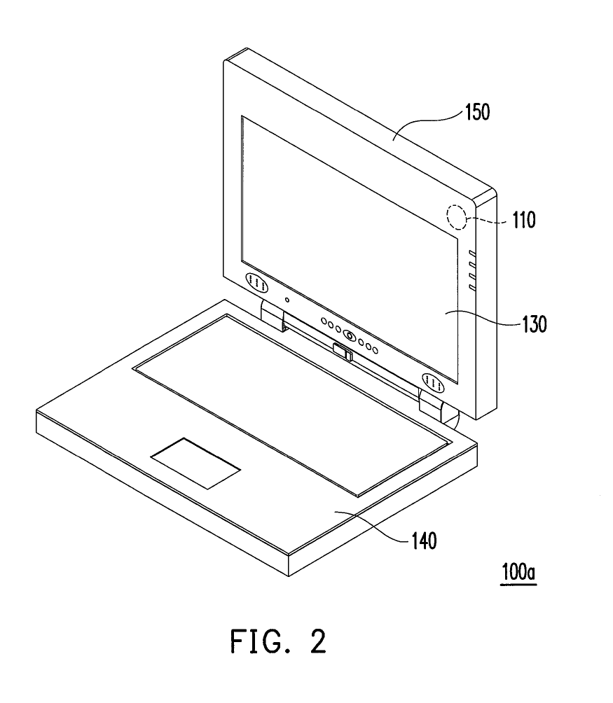

FIG. 2 is a three-dimensional schematic diagram showing a portable computer of another embodiment of the present invention. Referring to FIG. 2, the portable computer 100a of the embodiment includes all elements shown in FIG. 1, such as the environment parameter sensor 110, the data processing module 120 and the screen 130, and the portable computer 100a has all functions of the portable computer 100. The portable computer 100a is a notebook computer including a computer system base 140 and a display 150, wherein the computer system base 140 is connected to the display 150. The data processing module (not shown) is, for example, provided in the computer system base 140, and the screen 130 is provided on the display 150.

In the present embodiment, the environment parameter sensor 110 is provided on the display 150, while in other embodiments of the present invention, the environment parameter sensor 110 is provided on the computer system base 140. Further, in the present embodiment, the environment parameter sensor 110 is coated at one corner of the screen 130, while in other embodiments of the present invention, the environment parameter sensor 110 is provided on one side of the screen 130 or other proper locations in the portable computer 100a.

When the environment parameter sensor 110 includes a temperature sensor unit, it is better for the temperature sensor unit to be placed away from the computer system base 140. Since the heat generated by the computer system base 140 would affect the accuracy of the temperature sensed by the temperature sensor unit. For example, the temperature sensor unit can be provided on the display 150, on one side of the screen 130 or at one corner of the screen 130.

Moreover, when the environment parameter sensor 110 includes more than two sensor units having different functions, the sensor units can be provided adjacent to each other or away from each other. If the sensor units are away from each other, one sensor unit is, for example, provided on the display 150, and another sensor unit is, for example, provided on the computer system base 140.

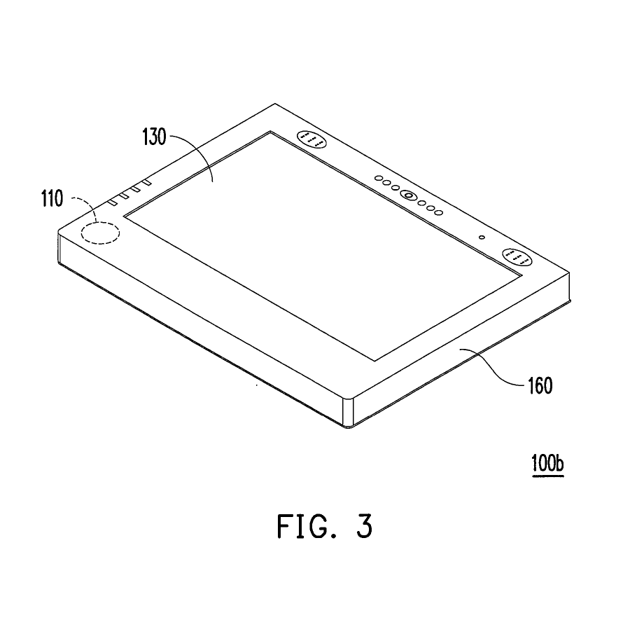

FIG. 3 is a three-dimensional schematic diagram showing a portable computer of another embodiment of the present invention. Referring to FIG. 3, the portable computer 100b of the embodiment includes all elements, such as the environment parameter sensor 110, the data processing module 120 and the screen 130, and all functions of the portable computer 100 shown in the FIG. 1. The portable computer 100b is a tablet personal computer, and the data processing module (not shown), screen 130 and environment parameter sensor 110 are provided on the same body 160.

In the present embodiment, the environment parameter sensor 110 is provided at one corner of the screen 130, while in other embodiments of the present invention is provided on one side of the screen 130, or it can be provided at other proper locations in the portable computer 100b based on varies situations.

When the environment parameter sensor 110 includes temperature sensor unit, it is better for the temperature sensor unit to be provided away from the data processing module to prevent the heat generated by the data processing module from affecting the accuracy of the temperature value sensed by the temperature sensor unit. For example, the temperature sensor unit can be located at one side of the screen 130 or at one corner of the screen 130.

Moreover, when the environment parameter sensor 110 includes more than two sensor units having different functions, the sensor units can be provide adjacent to each other or away from each other. If the sensor units are away from each other, one sensor unit is, for example, located at one corner of the screen 130, and another sensor unit is, for example, located at another corner of the screen 130.

In addition, the portable computer 100a and 100b shown in the FIG. 2 and FIG. 3, respectively, can further include a hard disk (not shown) electrically connected to the data processing module. The hard disk is suitable to store huge amounts of data. In addition, the portable computer 100a and 100b can be connected to a computer expanding base (not shown). The expanding base includes, for example, a compact disc (CD) driver, an expanding hard disk, a loudspeaker, a microphone and so on. In this way, the portable computers 100a and 100b can expand the functions via the computer expanding bases.

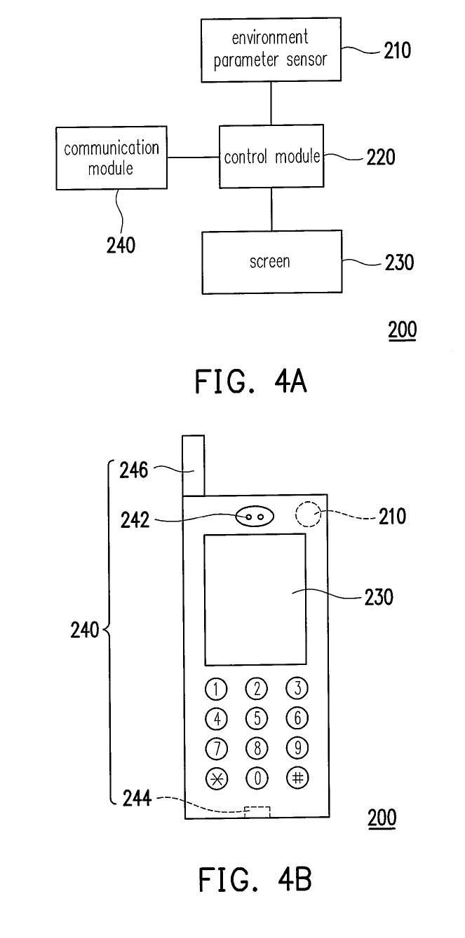

FIG. 4A is a block diagram showing a mobile phone of one embodiment of the present invention, and FIG. 4B is a schematic diagram showing the mobile phone shown in the FIG. 4A. Referring to FIG. 4A and FIG. 4B, the mobile phone 200 of the embodiment includes a control module 220, a communication module 240, an environment parameter sensor 210 and a screen 230. The communication module 240 is electrically connected to the control module 220. The environment parameter sensor 210 is electrically connected to the control module 220 to transmit a sensed environment parameter to the control module 220. The screen 230 is electrically connected to the control module 220 to show the environment parameter.

In the embodiment, the environment parameter sensed by the environment parameter sensor 210 and shown by the screen 230 includes at least one of the temperature, the orientation, the pressure and the altitude, wherein the orientation means the direction that the mobile phone 200 locates, which may be east, west, south, north or more precise direction. Certainly, the environment parameter can also be the longitude, the latitude or other environment parameters. For example, the environment parameter sensor 210 includes at least one of a temperature sensor unit, an orientation sensor unit, a pressure sensor unit and an altitude sensor unit to sense the temperature, orientation, pressure and altitude. Moreover, the communication module 240 can obtain the communication function by converting the voice to the electrical signals transmitted via a communication network and converting the electrical signals received via the communication network to the voice. For example, the communication module 240 includes a speaker 242, a receiver 244 and an antenna 246, wherein the speaker 242 is used to convert the electrical signals to voice, while the receiver 244 is used to convert the voice to the electrical signals, and the antenna 246 is used to transmit and receive the electrical signals via the communication network.

Since the mobile phone 200 of the embodiment has the environment parameter sensor 210, the environment parameter can be sensed timely and locally and shown on the screen 230. In this way, users can obtain the environment parameter timely and locally without carrying and using other electronic apparatuses. Thus, the mobile phone 200 of the embodiment can bring much convenience to users.

In the embodiment, the environment parameter sensor 210 is located at one corner of the screen 230, while in other embodiments of the present invention is at one side of the screen 230 or other proper locations in the mobile phone 200 according to the actual need.

When the environment parameter sensor 210 includes a temperature sensor unit, it is better for the temperature sensor unit to be provided away from the control module 220 to prevent the heat generated by the control module 220 from affecting the accuracy of the temperature value sensed by the temperature sensor unit. For example, the temperature sensor unit can be provided on one side of the screen 230 or at the corner of the screen 230.

Moreover, when the environment parameter sensor 210 includes more than two sensor units having different functions, the sensor units can be provided adjacent to each other or away from each other. If the sensor units are away from each other, one sensor unit is, for example, provided at one corner of the screen 230, and another sensor unit is, for example, provided at another corner of the screen 230.

According to the description above, since the portable computer and mobile phone of this invention have environment parameter sensors, the temperature, orientation, pressure, altitude and other environment parameters can be sensed timely and locally and shown in the screens. In this way, users can obtain the environment parameters timely and locally without carrying and using other electronic apparatuses. Thus, the portable computer and mobile phone of the present invention can bring users much convenience.

Although the present invention has been described in considerable detail with reference to certain preferred embodiments thereof, the disclosure is not for limiting the scope of the present invention. Persons having ordinary skill in the art may make various modifications and changes without departing from the scope and spirit of the present invention. Therefore, the scope of the appended claims should not be limited to the description of the preferred embodiments described above.

What is claimed is:

1. A portable computer comprising:
a data processing module;
an environment parameter sensor electrically connected to the data processing module to transmit a sensed environment parameter to the data processing module; and
a screen electrically connected to the data processing module to show the environment parameter.

2. The portable computer according to claim 1, wherein the environment parameter comprises temperature.

3. The portable computer according to claim 1, wherein the environment parameter comprises orientation.

4. The portable computer according to claim 1, wherein the environment parameter comprises pressure.

5. The portable computer according to claim 1, wherein the environment parameter comprises altitude.

6. The portable computer according to claim 1, wherein the environment parameter sensor is located at one side of the screen.

7. The portable computer according to claim 6, wherein the environment parameter sensor is located at one corner of the screen.

8. A mobile phone comprising:
a control module;
a communication module electrically connected to the control module;
an environment parameter sensor electrically connected to the control module to transmit a sensed environment parameter to the control module; and
a screen electrically connected to the control module to show the environment parameter.

9. The mobile phone according to claim 8, wherein the environment parameter comprises temperature.

10. The mobile phone according to claim 8, wherein the environment parameter comprises orientation.

11. The mobile phone according to claim 8, wherein the environment parameter comprises pressure.

12. The mobile phone according to claim 8, wherein the environment parameter comprises altitude.

13. The mobile phone according to claim 8, wherein the environment parameter sensor is located at one side of the screen.

14. The mobile phone according to claim 13, wherein the environment parameter sensor is located at one corner of the screen.
